(19) United States
(12) Patent Application Publication
(10) Pub. No.: US 2017/0230210 A1
(43) Pub. Date: Aug. 10, 2017

(54) INTERFERENCE CANCELLATION IN RADIO TRANSCEIVERS

(71) Applicant: QUALCOMM Incorporated, San Diego, CA (US)

(72) Inventors: Madihally Narasimha, Saratoga, CA (US); Gurkanwal Sahota, San Diego, CA (US); Raheel Khan, Tustin, CA (US)

(21) Appl. No.: 15/427,046

(22) Filed: Feb. 7, 2017

Related U.S. Application Data
(60) Provisional application No. 62/292,855, filed on Feb. 8, 2016.

(51) Int. Cl. H04L 25/08; H04B 7/06; H04L 25/03; H04W 52/52

(52) U.S. Cl. CPC H04L 25/08; H04W 52/52; H04B 7/0639; H04L 25/03853; H04W 88/06

(57) ABSTRACT

Methods, systems, and devices for wireless communication are described. A user equipment (UE) may tune an auxiliary receiver within a first radio to a transmission frequency of a co-located second radio. The auxiliary receiver may downconvert a signal from the second radio so that the UE may generate an interference estimate and perform interference cancellation. In some cases, the auxiliary receiver may also be used to perform transmission corrections for transmissions of the first radio. For example, the auxiliary receiver may be used to enable gain control or digital predistortion. The auxiliary receiver may be selectively tuned to the transmission frequency of the first radio or the second radio based on whether the auxiliary receiver is being used to perform interference cancellation or transmission correction.

### CROSS REFERENCES

The present Application for Patent claims priority to U.S. Provisional Patent Application No. 62/292,855 by Narasimha, et al., entitled “Interference Cancellation In Co-located Multiple Radio Transceivers,” filed Feb. 8, 2016, assigned to the assignee hereof, and which is hereby expressly incorporated by reference herein in its entirety.

### TECHNICAL FIELD

The following relates generally to wireless communication, and more specifically to interference cancellation in radio transceivers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may be otherwise known as user equipment (UE).

In some cases, a UE may include multiple transceivers and/or may be located in proximity to other transceivers. For example, a UE may include transceivers for a wireless wide area network (WWAN) and for a wireless local area network (WLAN). In some cases, transmissions from one transceiver may cause interference at another transceiver. This may result in dropped packets, delays, and disruptions to the communications link in one or both of the transceivers. Thus, improved methods of interference cancellation are desired.

### SUMMARY

A user equipment (UE) may tune an auxiliary receiver within a first radio to a transmission frequency of a co-located second radio. The auxiliary receiver may downconvert a signal from the co-located second radio so that the UE may generate an interference estimate and perform interference cancellation. In some cases, the auxiliary receiver may also be used to perform transmission corrections for transmissions of the first radio. For example, the auxiliary receiver may be used to enable gain control or digital predistortion with respect to the first radio. The auxiliary receiver may be selectively tuned to the transmission frequency of the first radio or the second radio based on whether the auxiliary receiver is being used to perform interference cancellation or transmission correction.

A device for wireless communication is described. The device may include a first radio configured to process signals received wirelessly at a reception frequency, the first radio comprising a receive chain, an auxiliary receive chain, and an interference cancellation circuit. The device may also include a second radio configured to generate signals for wireless transmission at a transmission frequency. The first radio may be configured to process a first signal that includes a data signal received in the reception frequency and an interference signal based on the transmission frequency. The receive chain may include a low noise amplifier (LNA) configured to output an amplified signal having an amplified interference signal and an amplified data signal. In some cases, an input of the auxiliary receive chain may be configured to be coupled to the receive chain such that the amplified interference signal output by the LNA is input to the auxiliary receive chain. The interference cancellation circuit may be configured to generate an interference estimate based at least in part on the amplified interference signal and apply the interference estimate to the amplified signal of the receive chain.

A method of wireless communication is described. The method may include receiving a wireless signal at a first radio, where the wireless signal includes a data signal based on a reception frequency of the first radio and an interference signal based on a transmission frequency of a second radio, amplifying the received wireless signal to produce an amplified data signal and an amplified interference signal, generating an interference estimate based at least in part on the amplified interference signal, and performing an interference cancellation procedure on the received wireless signal based at least in part on the interference estimate.

An apparatus for wireless communication is described. The apparatus may include means for transmitting a first wireless signal at a transmission frequency, means for receiving a second wireless signal, where the second wireless signal includes a data signal based on a reception frequency of the means for receiving and an interference signal based on the transmission frequency, means for performing an LNA of the received wireless signal and outputting an amplified data signal and an amplified interference signal, means for generating an interference estimate based at least in part on the amplified interference signal, and means for performing an interference cancellation procedure on the received wireless signal based at least in part on the interference estimate.

Another apparatus for wireless communication is described. The apparatus may include a processor, memory in electronic communication with the processor, and instructions stored in the memory. The instructions may be operable to cause the processor to transmit a first wireless signal at a transmission frequency, receive a second wireless signal, where the second wireless signal includes a data signal based on a reception frequency of the means for receiving and an interference signal based on the transmission frequency, perform an LNA of the received wireless signal and output an amplified data signal and an amplified interference signal, generate an interference estimate based at least in part on the amplified interference signal, and perform an interference cancellation procedure on the received wireless signal based at least in part on the interference estimate.

Another apparatus for wireless communication is described. The apparatus may include an LNA having an input coupled to a first antenna and an LNA output, where the LNA is configured to provide at the output an amplified signal based on a first signal wirelessly received at the first antenna. The apparatus may also include a data processing path coupled to the LNA output and including a first receiver, and an interference processing path coupled to the LNA output and including a feedback receiver. The apparatus may also include a combiner configured to combine an output of the data processing path with an output of the interference processing path, and a power amplifier coupled to the interference processing path. The apparatus may also include a multiplexer configured to selectively couple the LNA output or the power amplifier to circuitry in the feedback receiver. In some cases, the apparatus may be implemented in a first device and may be configured to transmit and receive wireless signals using a first radio access technology (RAT), wherein the first device further includes a transceiver coupled to a second antenna and configured to transmit and receive wireless signals using a second RAT.

A non-transitory computer readable medium for wireless communication is described. The non-transitory computer-readable medium may include instructions operable to cause a processor to transmit a first wireless signal at a transmission frequency, receive a second wireless signal, where the second wireless signal includes a data signal based on a reception frequency of the means for receiving and an interference signal based on the transmission frequency, perform an LNA of the received wireless signal and output an amplified data signal and an amplified interference signal, generate an interference estimate based at least in part on the amplified interference signal, and perform an interference cancellation procedure on the received wireless signal based at least in part on the interference estimate.

Some examples of the device, method, apparatus, and non-transitory computer-readable medium described above may further include processes, features, means, or instructions for processing the amplified data signal in a first receive path using at least a first downconverter and processing the amplified interference signal in a second receive path using at least a second downconverter, where the interference estimate is based at least in part on the amplified interference signal processed in the second receive path, and where the performing is based at least in part on the amplified data signal processed in the first receive path.

Some examples of the device, method, apparatus, and non-transitory computer-readable medium described above may further include processes, features, means, or instructions for tuning an auxiliary receiver of the first radio to the transmission frequency of the second radio. Some examples of the device, method, apparatus, and non-transitory computer-readable medium described above may further include processes, features, means, or instructions for converting the amplified interference signal to a baseband frequency of the second radio based at least in part on tuning the auxiliary receiver to the transmission frequency of the second radio.

Some examples of the device, method, apparatus, and non-transitory computer-readable medium described above may further include processes, features, means, or instructions for tuning the auxiliary receiver to a transmission frequency of the first radio. Some examples of the device, method, apparatus, and non-transitory computer-readable medium described above may further include processes, features, means, or instructions for converting a transmission signal from the first radio to a baseband frequency of the first radio based at least in part on tuning the auxiliary receiver to the transmission frequency of the first radio. Some examples of the device, method, apparatus, and non-transitory computer-readable medium described above may further include processes, features, means, or instructions for performing a transmission correction procedure based at least in part on the converted transmission signal.

In some examples of the device, method, apparatus, and non-transitory computer-readable medium described above, the auxiliary receiver may be selectively coupled to at least one of a digital predistortion and gain control path associated with a transmit path of the first radio, or a receive path associated with the first radio. Some examples of the device, method, apparatus, and non-transitory computer-readable medium described above may further include processes, features, means, or instructions for determining to convert the amplified interference signal to the baseband frequency of the second radio. Some examples of the device, method, apparatus, and non-transitory computer-readable medium described above may further include processes, features, means, or instructions for selectively causing the auxiliary receiver to switch coupling from a digital predistortion and gain control path associated with the transmit path of the first radio to the receive path associated with the first radio.

Some examples of the device, method, apparatus, and non-transitory computer-readable medium described above may further include processes, features, means, or instructions for digitizing the amplified interference signal, where the interference estimate may be based at least in part on the digitized interference signal. Some examples of the device, method, apparatus, and non-transitory computer-readable medium described above may further include processes, features, means, or instructions for converting the data signal to a baseband data signal, where performing the interference cancellation procedure may be based at least in part on the baseband data signal.

In some examples of the device, method, apparatus, and non-transitory computer-readable medium described above, the first radio includes a wireless wide area network (WWAN) radio and the second radio includes a wireless local area network (WLAN) radio. In some examples of the device, method, apparatus, and non-transitory computer-readable medium described above, the interference cancellation procedure may be further based on a transmission signal from the first radio. Some examples of the device, method, apparatus, and non-transitory computer-readable medium described above may further include processes, features, means, or instructions for sending a universal asynchronous receiver/transmitter (UART) message from the second radio to the first radio, where generating the interference estimate may be based at least in part on the UART message.

Some examples of the device, method, apparatus, and non-transitory computer-readable medium described above may further include processes, features, means, or instructions for demodulating the data signal based at least in part on the interference cancellation procedure. In some examples of the device, method, apparatus, and non-transitory computer-readable medium described above, the first radio communicates using a first RAT and the second radio communicates using a second RAT. In some cases, the reception frequency of signals received by the first radio configured to use the first RAT may be different from the transmission frequency of signals generated for wireless transmission at the second radio configured to use the second RAT.

### BRIEF DESCRIPTION OF THE DRAWINGS

FIG. 1 illustrates an example of a wireless communications system in accordance with various aspects of the present disclosure;

FIG. 2 illustrates an example of a wireless communications system in accordance with various aspects of the present disclosure;

FIG. 3A illustrates an example of a radio configuration in a system that supports interference cancellation in accordance with various aspects of the present disclosure;

FIG. 3B illustrates an example of a radio configuration in a system that supports interference cancellation in accordance with various aspects of the present disclosure;

FIG. 3C illustrates an example of an auxiliary receiver in a system that supports interference cancellation in accordance with various aspects of the present disclosure;

FIGS. 4 through 6 show block diagrams of a wireless device that supports interference cancellation in accordance with various aspects of the present disclosure;

FIG. 7 illustrates a block diagram of a system including a device that supports interference cancellation in accordance with various aspects of the present disclosure;

FIGS. 8 through 11 illustrate methods for interference cancellation in accordance with various aspects of the present disclosure.

### DETAILED DESCRIPTION

Interference (e.g., nonlinear interference) may cause a degradation in received signal quality. For example, nonlinear interference may be caused by one or more transmitters and/or receivers within close geographical proximity to one another (i.e., co-located). Co-located transmitters and receivers may refer to transmitters and receivers in the same device or otherwise within close geographical proximity to one another, such that signals from a transmitter may cause interference at a co-located receiver. The transmitters and/or receivers may belong to the same radio access technology (RAT), or the transmitters and/or receivers may belong to different RATs. When the transmitters and/or receivers are of the same RAT, both interference mitigation and interference cancellation may be used to increase received signal quality.

To facilitate interference cancellation when a user equipment (UE) has multiple radios, the UE may tune an auxiliary receiver within a first radio to a transmission frequency of a second radio. The auxiliary receiver may downconvert a signal from the second radio so the UE may generate an interference estimate and perform interference cancellation. In some cases, the auxiliary receiver may also be used to perform transmission corrections for transmissions of the first radio. For example, the auxiliary receiver may be used to enable gain control or digital predistortion. The auxiliary receiver may be selectively tuned to the transmission frequency of the first radio or the second radio based on whether the auxiliary receiver is being used to perform interference cancellation or transmission correction.

Aspects of the disclosure are initially described in the context of a wireless communication system. An example of a device that supports interference cancellation is then described. Aspects of the disclosure are further illustrated by and described with reference to apparatus diagrams, system diagrams, and flowcharts that relate to interference cancellation in co-located transceivers.

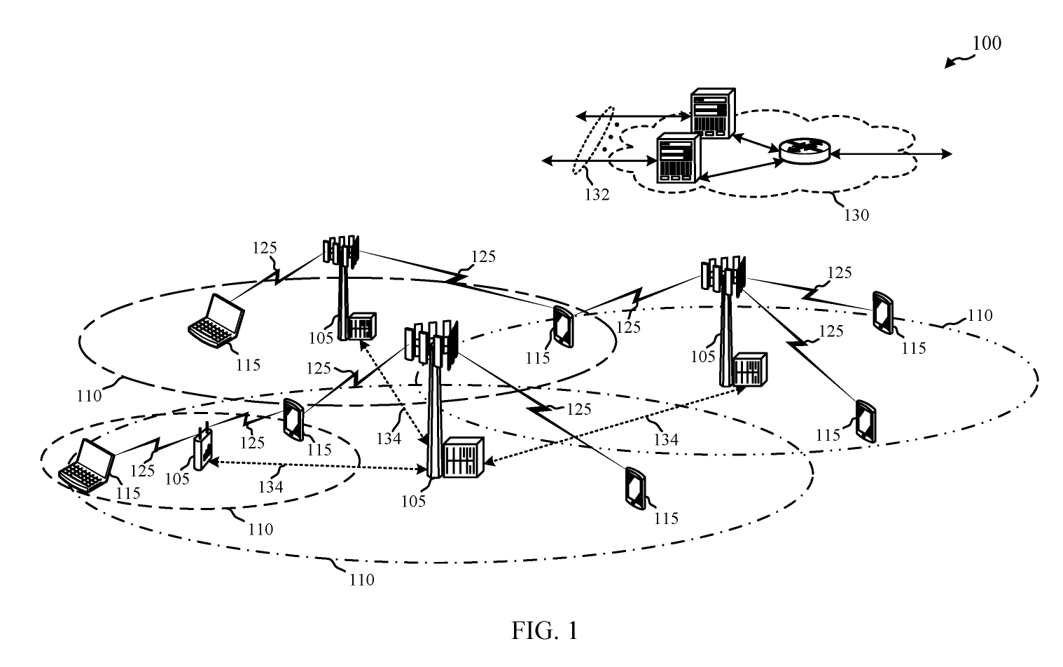

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. One or more devices within wireless communications system 100 may support interference cancellation of signals from co-located radios.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

In some cases, a UE 115 may contain multiple radios. For example, a UE 115 may contain a first radio for communicating on wireless communications system 100 (e.g., a wireless wide area network (WWAN)) and a second radio for communicating on a system using a different RAT such as a wireless local area network (WLAN) or Bluetooth. A UE 115 with multiple radios may tune an auxiliary receiver within the first radio to a transmission frequency of the second radio. The auxiliary receiver may downconvert a signal from the second radio so that the UE 115 may generate an interference estimate and perform interference cancellation. In some cases, the auxiliary receiver may also be used to perform transmission corrections for transmissions of the first radio. For example, the auxiliary receiver may be used to enable gain control or digital predistortion. The auxiliary receiver may be selectively tuned to the transmission frequency of the first radio or the second radio based on whether the auxiliary receiver is being used to perform interference cancellation or transmission correction.

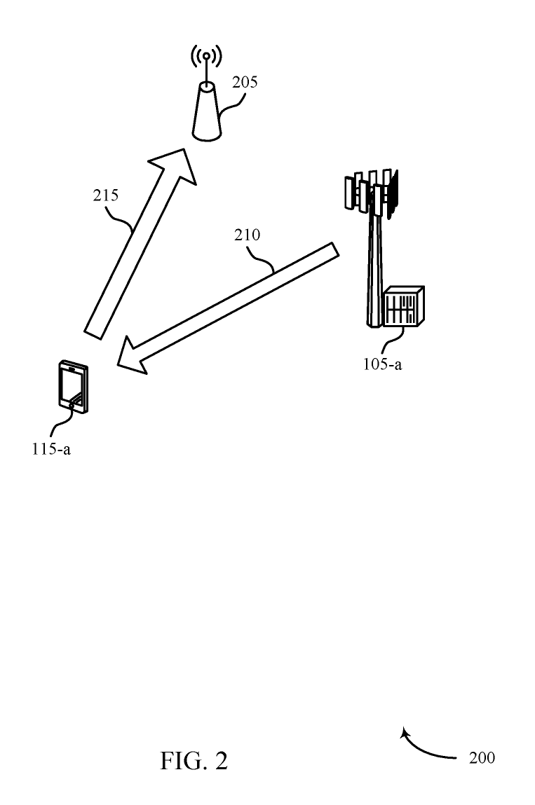

FIG. 2 illustrates an example of a wireless communications system 200. Wireless communications system 200 may include a base station 105-a, a WLAN access point (AP) 205, and UE 115-a, which may be examples of the corresponding devices described with reference to FIG. 1. UE 115-a may support interference cancellation of signals from co-located radios.

Nonlinear interference may be caused by multiple radios within UE 115-a. For example, one radio may be used to communicate with base station 105-a over communication link 210 and another radio may be used to communicate with AP 205 over communication link 215. Each radio frequency (RF) transceiver chain may include several receiving and/or transmitting components to assist in receiving and transmitting RF signals. That is, each radio within UE 115-a may include components of a transmitter chain and a receiving chain.

In some cases, the radios used within UE-115-a for communication with base station 105-a and AP 205 may include auxiliary receivers to support interference cancellation and transmission correction. As an example, the auxiliary receiver at the first radio used for communication with base station 105-a may receive the signal transmitted by the second radio used for communication with AP 205 in addition to receiving signals from the base station 105. The first radio may then process the signal received from the second radio to cancel the interference to the signal received from base station 105-a. The first radio may also identify the power of the signal transmitted to AP 205, and the first radio may use this information to correct the power used for a subsequent transmission.

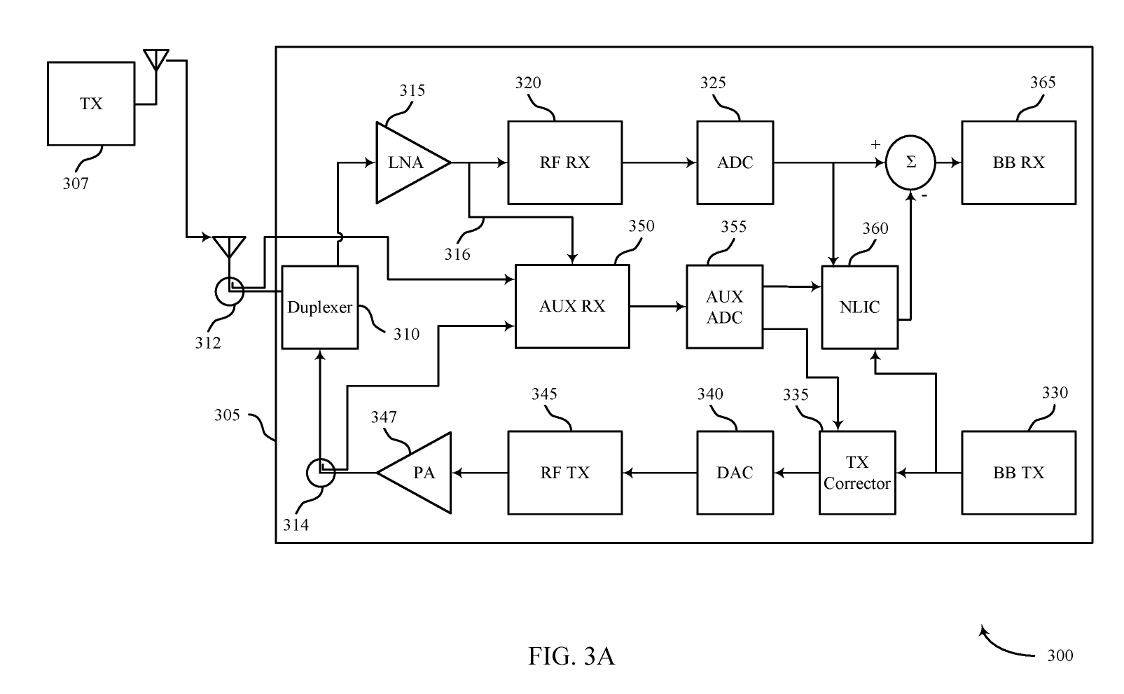

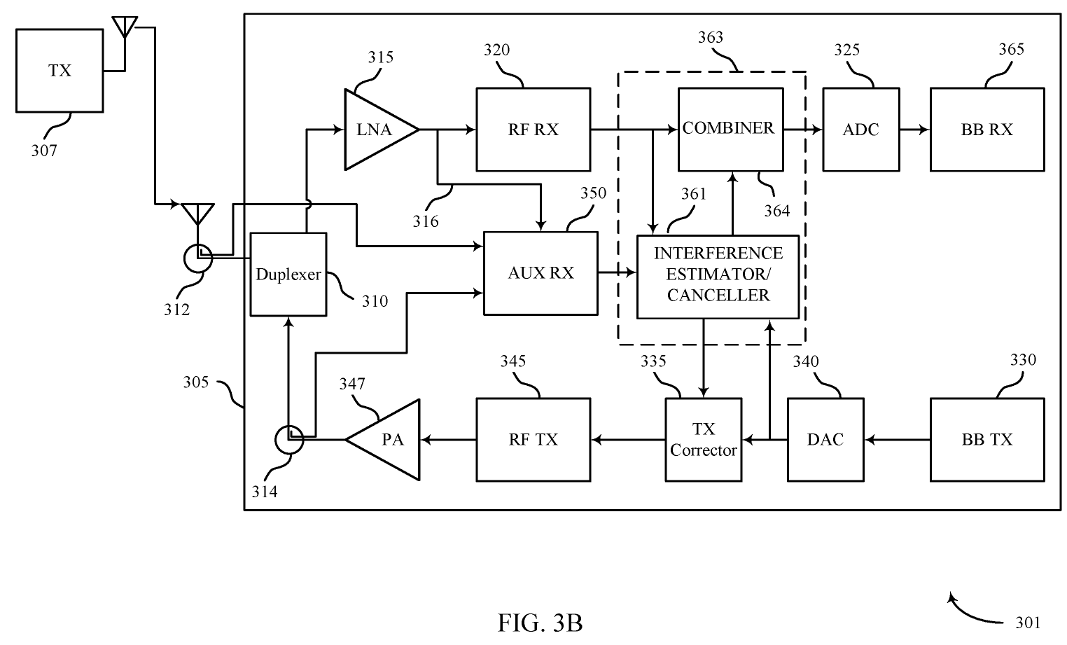

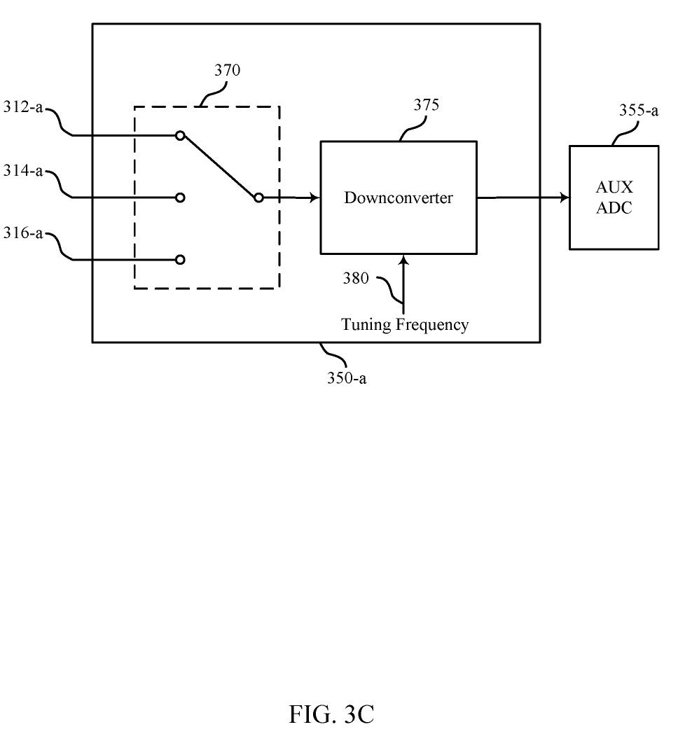

FIG. 3A illustrates an example of a radio configuration 300 in a system that supports interference cancellation in co-located radio transceivers in accordance with various aspects of the present disclosure. A first radio 305 may be in close proximity to a second radio 307 and may receive interference from the second radio 307 when the first radio 305 is receiving an RF signal from, for example, a base station 105 (not shown).

The interference and the RF signal may be received at duplexer 310. Duplexer 310 may then send the interference to a receive chain. The receive chain may include LNA 315, which may amplify a low power signal without significantly degrading the signal's signal-to-noise ratio (SNR). In some cases, LNA 315 may also amplify noise present in the signal, for example which may include the interference received. The RF signal may then be sent to an RF receiver (RF RX) 320. RF RX 320 may transform the RF signal into a baseband signal. For example, the RF RX 320 may include one or more mixers to downconvert the RF signal. Further, the RF RX 320 may include additional amplifiers, filters, matching circuits, and/or other elements commonly implemented in RF receive circuitry. The baseband signal may then pass through a analog-to-digital converter (ADC) 325. ADC 325 may transform the baseband signal received from RF RX 320 into a digital signal. The ADC 325 may subsequently send the digital baseband signal to a baseband receiver (BB RX) 365. The BB RX 365 may demodulate the digital baseband signal. Demodulating the digital baseband signal may include extracting the information from the digital baseband signal (i.e., based on the modulation and coding scheme (MCS) of the signal).

Additionally, first radio 305 may include a baseband transmitter (BB TX) 330. BB TX 330 may create a baseband signal. The baseband signal may be a digital signal and may be of a lower frequency than the corresponding RF signal to be transmitted. In some cases, the baseband signal frequency may be determined by an intended data rate of the signal and the modulation scheme for the signal. For example, for a 10 Mbps data rate with 4 quadrature amplitude modulation (QAM), the baseband signal frequency may be 2.5 MHz. The baseband signal may pass through transmission corrector 335. Transmission corrector 335 may perform gain control and predistortion corrections (e.g., if a power output of a previous RF signal transmission was above or below a desired power output).

The baseband signal may then pass through a digital-to-analog converter (DAC) 340. DAC 340 may transform the baseband signal into an analog signal and subsequently send the converted baseband signal to RF transmitter (RF TX) 345. RF TX 345 may receive the converted baseband signal from DAC 340 and transform it into an RF signal by placing the baseband signal onto an RF carrier. The RF signal may be of a higher frequency than the corresponding baseband signal.

The RF signal may then pass through a power amplifier (PA) 347. The PA 347 may amplify the power of the RF signal to a level suitable for transmitting the RF signal. The RF signal may then be sent to a duplexer 310 for transmission. The duplexer 310 may allow for bidirectional communication over a single antenna (or antenna array). The duplexer 310 may route and filter signals from both the receiver and the transmitter. That is, the duplexer may isolate the receiver and the transmitter while allowing the receiver and the transmitter to share a common antenna.

In some cases, the output of the LNA 315 may be coupled with an auxiliary receiver 350 in addition to being coupled with the RF RX 320.

Further, in some cases, the digital baseband signal may be modified based on an estimate of interference from a co-located transmitter and/or receiver (i.e., a transmitter and/or receiver within close geographical proximity) prior to being provided to the BB RX 365.

For example, a receiving chain of a UE may include the auxiliary receiver 350 to assist in interference cancellation. The auxiliary receiver 350 may downconvert a signal from the second radio so the UE may generate an interference estimate and perform interference cancellation. As an example, the auxiliary receiver 350 may be coupled to the duplexer 310 or the LNA 315.

To facilitate interference cancellation, coupler 312 may send a received RF signal to auxiliary receiver 350 (e.g., which may serve both for interference cancellation and to provide feedback to the transmission corrector 335 as part of the transmit chain). Additionally or alternatively, the received RF signal may be sent to auxiliary receiver 350 after first passing through the LNA 315. In some cases, auxiliary receiver 350 may be selectively coupled to the output of LNA 315 via connection 316. Auxiliary receiver 350 may be configured as a feedback receiver; in contrast to known feedback receivers, however, the auxiliary receiver 350 may be coupled to an output of the LNA 315 (e.g., over the coupling 316) instead of or in addition to being coupled to an output of the PA 347. Auxiliary receiver 350 may be selectively tuned to the interference frequency from second radio 307. Auxiliary receiver 350 may then pass the RF interference signal through an ADC such as AUX ADC 355, which may digitize the RF interference signal and may send the digitized RF signal to nonlinear interference cancelation (NLIC) block 360. In some cases, NLIC block 360 may also receive a baseband signal from BB TX 330. NLIC block 360 may compute an estimate of the interference (e.g., using nonlinear adaptive filter techniques). In some embodiments, the interference is estimated using blocks, circuitry, and/or methodology other than NLIC. The resulting interference estimate may then be subtracted from the received RF signal to create a clean RF signal. The clean RF signal may then be sent to BB RX 365. In some embodiments, the BB RX 365 and the BB TX 330 are implemented on a common chip, for example a modem and/or baseband processing chip.

In some cases, a transmitting chain of UE 115-a may receive a signal or other input from the auxiliary receiver 350, e.g., via the AUX ADC 355, to assist in correcting power output of the transmitter. For example, the power output for a transmitted signal may be more or less than a desired signal power output after passing through the PA 347. The auxiliary receiver 350 may receive the transmitted signal from the PA 347 (e.g., through coupler 314) or the duplexer 310. The auxiliary receiver 350 may then determine a power output of the related transmitted signal and indicate the power output to the BB TX 330. If the power output is above or below the signal power threshold, then a subsequent baseband signal that is to be transmitted may be modified in a transmission correction module to achieve the desired signal power. Auxiliary receiver 350 may be used in conjunction with AUX ADC 355 and transmission corrector 335 to predistort and modify the power output of transmitted signals.

Therefore, auxiliary receiver 350 may be selectively used to provide an interference estimate for a received wireless signal and/or as an indication of the TX predistortion and the power output to transmission corrector 335. In some cases, the auxiliary receiver 350 used to assist in interference cancellation may be the same auxiliary receiver 350 that is used to perform transmission corrections for transmissions of the first radio 305 (although a separate receiver may also be used). If the same auxiliary receiver 350 is used for both interference cancellation and transmission correction, it may be selectively tuned to a transmission frequency of the first radio or the second radio based on whether it is performing interference cancellation or transmission correction.

In some embodiments, interference estimation and/or cancellation may be performed in analog circuitry instead of or in addition to in a digital domain. An example configuration of a system utilizing analog interference cancellation is illustrated in FIG. 3B.

FIG. 3B illustrates an example of a radio configuration 301 in a system that supports interference cancellation in co-located radio transceivers in accordance with various aspects of the present disclosure. Elements which are common with FIG. 3A are similarly labeled.

In FIG. 3B, an output of the auxiliary receiver 350 is coupled to an interference cancellation circuit 363. The interference cancellation circuit 363 is configured to cancel, mitigate, and/or reduce interference in a signal processed by a data path including the RF RX 320. In this way, signals may be output from the LNA 315 to an interference cancellation path including the auxiliary receiver 350.

The interference cancellation circuit 363 includes an interference estimator and/or canceller 361 coupled to an output of the auxiliary receiver 350. In some embodiments, an output of the interference estimator and/or canceller 361 comprises an analog signal which will cancel, mitigate, and/or reduce interference in a signal being processed by the data path when combined with that signal. This analog signal may be generated by the interference estimator and/or canceller 361 based at least in part on an output of the auxiliary receiver 350. To facilitate combining such analog signal with the signal being processed in the data path, the interference cancellation circuit 363 may include a combiner 364 which is coupled to outputs of both the RF RX 320 and the interference estimator and/or canceller 361. In some embodiments, the combiner 364 is implemented as the summation or subtraction circuit (e.g., as an adder) illustrated in FIG. 3A as being coupled to the ADC 325 and the NLIC 360, and the BB RX 365.

An output of the combiner 364 is coupled to the ADC 365, which transforms the error cancelled signal into a digital signal and provides the digital signal to the BB RX 365. As illustrated, in some embodiments an output of the interference estimator and/or canceller 361 may be based at least in part on a signal output from the RF RX 320. In other embodiments, the coupled between the output of the RF RX 320 and the interference estimator and/or canceller 361 may be omitted. Similarly, the coupling between the output of the ADC 325 and the NLIC 360 in FIG. 3A may be omitted.

In the system 301 illustrated in FIG. 3B, an output of the DAC 340 may be input to the interference estimator and/or canceller 361. The interference estimator and/or canceller 361 may output an analog signal to the TX corrector 335 to enable correction of a transmit signal.

In some embodiments, both the interference estimator and/or canceller 361 illustrated in FIG. 3B and the NLIC (or other digital correction means) illustrated in FIG. 3A may be implemented in a system 300 and/or 301. In such embodiments, both analog and digital correction may be utilized for either RX or TX signals (or both), or analog correction may be used for one of the RX and TX signals while digital correction is used for the other.

The radio 305 may include signal processing elements other than those illustrated. For example, filters, matching circuits, couplers and/or switches other than those illustrated may be implemented in the radio 305. In some embodiments, all of the elements illustrated in the radio 305 are implemented in a common chip, integrated circuit, or module. In other embodiments, each of the elements is implemented separately and coupled together, for example as discrete components coupled together on a printer circuit board (PCB). In yet other embodiments, certain of the elements are implemented in a common circuit or IC (for example the LNA, data path, interference cancellation path, and DAC 340), while other elements (for example, the BB RX 365, BB TX 330, and PA 347) are implemented separate from that circuit or IC. In some embodiments, the BBRX 365 and the BB TX 330 are implemented in a common chip or processor. In some such embodiments, the NLIC 360 illustrated in FIG. 3A is implemented in the same processor or chip. In other such embodiments, the NLIC 360 is implemented separate from the BB RX 365 and/or the BB TX 330.

FIG. 3C illustrates an example of an auxiliary receiver 350-a in a system that supports interference cancellation in co-located radio transceivers in accordance with various aspects of the present disclosure. Auxiliary receiver 350-a may be an example of auxiliary receiver 350 as described with reference to FIG. 3A.

In some cases, auxiliary receiver 350-a may receive input signals from multiple RF devices (e.g., from coupler 312-a, coupler 314-a, or from an LNA 315 over connection 316-a). Auxiliary receiver 350-a may select an RF input (e.g., from coupler 312-a, coupler 314-a, or from an LNA 315 over connection 316-a) using switch 370. Auxiliary receiver 350-a may then use downconverter 375 to downconvert (i.e., translate) the RF signal from the selected RF input to an analog baseband signal, and output the analog baseband signal. The analog baseband signal may be digitized by AUX ADC 355-a and/or input to the combiner 364, for example. Thus, while an output of the downconverter 375 is illustrated in FIG. 3C as being coupled to the AUX ADC 355-a, other embodiments may be implemented. Downconverter 375 may include a number of RF quadrature mixers and analog baseband filters (not shown). In some examples, the output of the RF quadrature mixers may be coupled to the input of the analog baseband filters.

In some cases, downconverter 375 may receive an indication of a tuning frequency 380 which may be a center frequency of an RF signal. If the tuning frequency aligns with a transmission frequency of a first radio 305, auxiliary receiver 350-a may be used to perform transmission correction. Alternatively, if the tuning frequency aligns with a transmission frequency of a second radio 307, auxiliary receiver 350-a may be used to perform interference cancellation. In some embodiments, the switch 370 is implemented as a multiplexer configured to couple any of 312, 314, and 316 to the down-conversion circuity described above or other circuitry which may be implemented in the auxiliary receiver 350 (e.g., filters, additional amplifiers, etc.).

In some cases, the switch 370 may couple the output of an LNA over connection 316-a to the down-conversion circuitry described above. In such cases, auxiliary receiver 350-a may receive an amplified wireless signal including an amplified data signal and an amplified interference signal. Because the signals are amplified, auxiliary receiver 350-a may be able to differentiate the data signal included in the wireless signal from the interference signal included in the wireless signal. Auxiliary receiver 350-a may then generate an interference estimate based on the amplified interference signal and perform an interference cancellation procedure on the received wireless signal based on the interference estimate. Coupling the output of the LNA 315 to the auxiliary receiver 350-a may enable advantageous processing of a received signal to support interference cancellation using certain circuitry which may already be present in and/or used in other operations of the radio.

In embodiments in which the first radio 305 and the second radio 307 are implemented in the same device, the two radios may be logically and/or technologically delineated, for example based on the RAT each supports, and/or physically or implementationally delineated, for example based on components implementing each or a chip or circuit in which each is implemented. Other aspects or characteristics may also delineate or differentiate the first radio 305 from the second radio 307. Similarly, a first transceiver may be delineated or differentiated from a second transceiver based on any such aspects or characteristics.

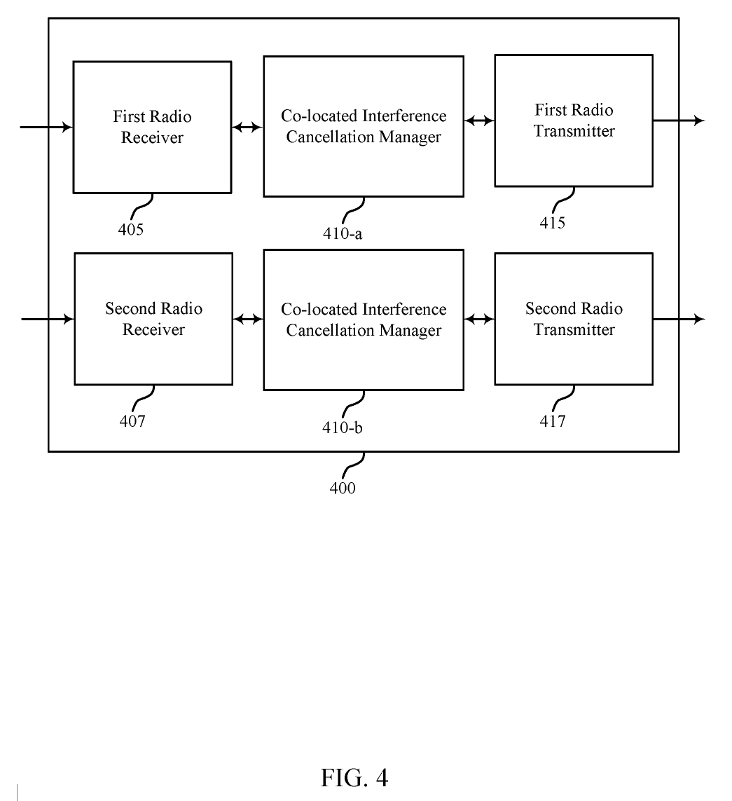

FIG. 4 shows a block diagram of a wireless device 400 that supports interference cancellation in co-located multiple radio transceivers in accordance with various aspects of the present disclosure. Wireless device 400 may be an example of aspects of a UE 115 described with reference to FIGS. 1 and 2, or components of a UE 115 described with reference to FIGS. 3A-3C. Wireless device 400 may include multiple co-located transceivers 405-415 and 407-417. For example, wireless device 400 may include a first radio receiver 405, a second radio receiver 407, co-located interference cancellation manager 410-a, co-located interference cancellation manager 410-b, first radio transmitter 415, and second radio transmitter 417. Wireless device 400 may also include a processor. Each of these components may be in communication with each other.

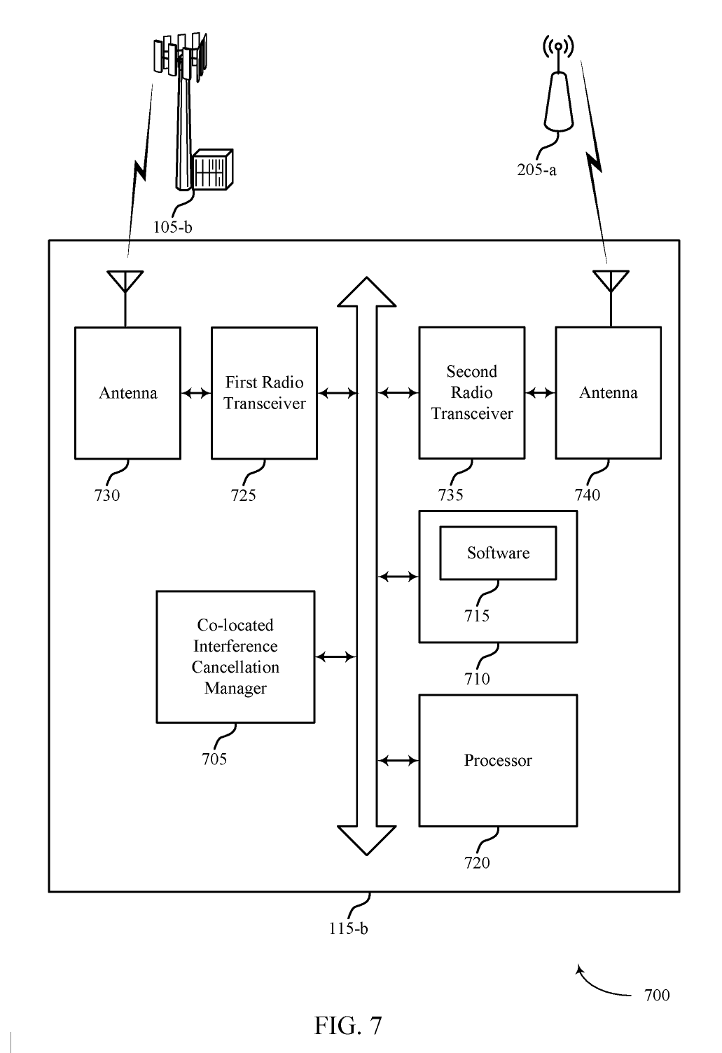

The first radio receiver 405 and second radio receiver 407 may receive information such as packets, user data, or control information associated with various information channels (e.g., control channels, data channels, information related to interference cancellation in co-located multiple radio transceivers, etc.). In some cases, the first radio receiver 405 may communicate using a first RAT (e.g., a WWAN RAT) and the second radio receiver 407 may communicate using a second RAT (e.g., a WLAN RAT or Bluetooth RAT). Information may be passed on to other components of the wireless device 400. The first radio receiver 405 may be an example of one or more components of the first radio transceiver 725 described with reference to FIG. 7. The second radio receiver 407 may be an example of one or more components of the second radio transceiver 735 described with reference to FIG. 7.

The first radio receiver 405 may receive a wireless signal and pass the signal to the co-located interference cancellation manager 410-a. The wireless signal may include a data signal based on a reception frequency of the first radio and an interference signal based on a transmission frequency of the second radio and may be amplified in the first radio receiver 405 to produce an amplified data signal and an amplified interference signal. The co-located interference cancellation manager 410 may convert the amplified interference signal to a baseband frequency of the second radio, generate an interference estimate based on the amplified interference signal, and perform an interference cancellation on the received wireless signal based on the interference estimate. The co-located interference cancellation manager 410-a may be an example of aspects of the co-located interference cancellation manager 705 described with reference to FIG. 7.

The first radio transmitter 415 and second radio transmitter 417 may transmit signals received from other components of wireless device 400. In some examples, the first radio transmitter 415 and second radio transmitter 417 may be co-located with first radio receiver 405 and second radio receiver 407, respectively, in co-located transceiver modules (e.g., a first radio and a second radio). The first radio transmitter 415 may be an example of one or more components of the first radio transceiver 725 described with reference to FIG. 7. The second radio transmitter 417 may be an example of one or more components of the second radio transceiver 735 described with reference to FIG. 7. The first radio transmitter 415 and second radio transmitter 417 may each include a single antenna, or may each include a plurality of antennas.

Using the techniques described herein, a UE may be able to mitigate interference (e.g., from Wi-Fi transmissions) at each of its radios (e.g., at LTE radios), and may thus improve throughput. The techniques described herein may be especially helpful for communication on overlapping frequency resources. Further, the techniques described herein may also be helpful for millimeter wave (mmW) communication on high frequency resources. Interference from transmissions on such high frequencies may be problematic. For example, aspects described herein may be used to cancel or mitigate interference in a received mmW 5G signal caused by a mmW WiFi transmission. Accordingly, the techniques described herein may be desirable for mitigating interference in a variety of contexts and at a variety of frequencies.

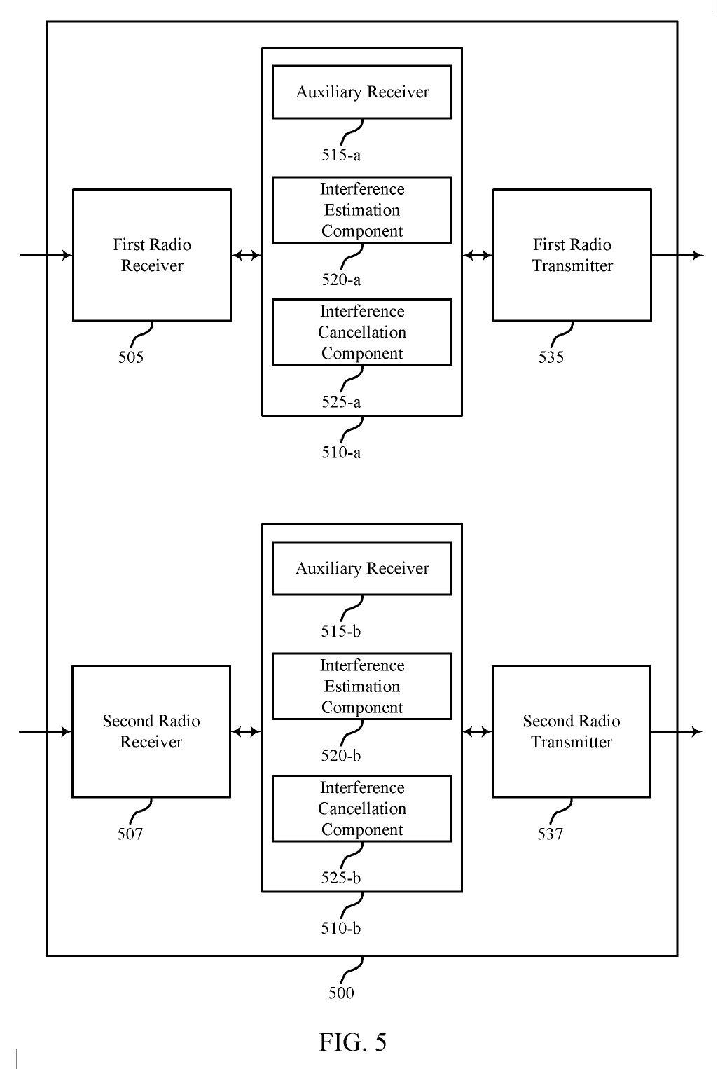

FIG. 5 shows a block diagram of a wireless device 500 that supports interference cancellation in co-located multiple radio transceivers in accordance with various aspects of the present disclosure. Wireless device 500 may be an example of aspects of a wireless device 400 or a UE 115 described with reference to FIGS. 1, 2 and 4, or components of a UE 115 described with reference to FIGS. 3A-3C. Wireless device 500 may include multiple co-located transceivers 505-535 and 507-537. For example, wireless device 500 may include a first radio receiver 505, a second radio receiver 507, co-located interference cancellation manager 510-a, co-located interference cancellation manager 510-b, first radio transmitter 535, and second radio transmitter 537. Wireless device 500 may also include a processor. Each of these components may be in communication with each other.

The first radio receiver 505 and second radio receiver 507 may receive information such as packets, user data, or control information associated with various information channels (e.g., control channels, data channels, information related to interference cancellation in co-located multiple radio transceivers, etc.). In some cases, the first radio receiver 505 may communicate using a first RAT (e.g., a WWAN RAT) and the second radio receiver 507 may communicate using a second RAT (e.g., a WLAN RAT or Bluetooth RAT). Information may be passed on to other components of the wireless device 500. The first radio receiver 505 may be an example of one or more components of the first radio transceiver 725 described with reference to FIG. 7. The second radio receiver 507 may be an example of one or more components of the second radio transceiver 735 described with reference to FIG. 7.

The first radio receiver 505 may also receive a wireless signal, where the wireless signal may include a data signal based on a reception frequency of the first radio and an interference signal based on a transmission frequency of the second radio, and convert the data signal to a baseband data signal, where performing an interference cancellation procedure is based on the baseband data signal.

The co-located interference cancellation managers 510 may be examples of aspects of co-located interference cancellation managers 410 described with reference to FIG. 4. The co-located interference cancellation managers 510 may include auxiliary receivers 515, interference estimation components 520, and interference cancellation components 525. In some cases, the auxiliary receiver 515-a may be included in the first radio receiver 505.

and the auxiliary receiver 515-b may be included in a second radio receiver 507. The co-located interference cancellation managers 510 may be examples of aspects of the co-located interference cancellation manager 705 described with reference to FIG. 7.

The auxiliary receiver 515-a may convert a transmission signal from the first radio to a baseband frequency of the first radio based on a prior step including tuning the auxiliary receiver to the transmission frequency of the first radio. The auxiliary receiver 515-a may also convert an interference signal to a baseband frequency of the second radio. The interference estimation component 520-a may generate an interference estimate based on the converted interference signal. Interference cancellation component 525-a may perform an interference cancellation procedure on a wireless signal including the interference signal based on the interference estimate. In some cases, the interference cancellation procedure is further based on a transmission signal from the first radio. In some case, interference cancellation component 525-a and interference estimation component 520-a may be located within an interference cancellation block as illustrated by NLIC block 360. Auxiliary receiver 515-b, interference estimation component 520-b, and interference cancellation component 525-b may support similar functions described above.

The first radio transmitter 535 and second radio transmitter 537 may transmit signals received from other components of wireless device 500. In some examples, the first radio transmitter 535 and second radio transmitter 537 may be co-located with first radio receiver 505 and second radio receiver 507, respectively, in co-located transceiver modules (e.g., a first radio and a second radio). The first radio transmitter 535 may be an example of one or more components of the first radio transceiver 725 described with reference to FIG. 7. The second radio transmitter 537 may be an example of one or more components of the second radio transceiver 735 described with reference to FIG. 7. The first radio transmitter 535 and second radio transmitter 537 may each include a single antenna, or may each include a plurality of antennas.

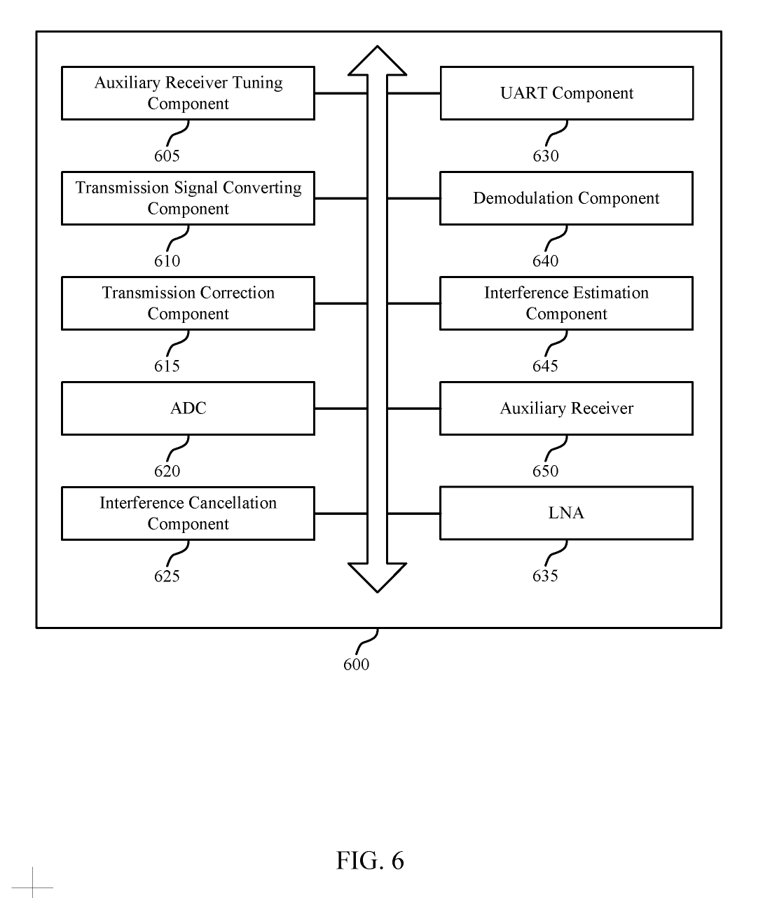

FIG. 6 shows a block diagram of a co-located interference cancellation manager 600 which may be an example of the corresponding component of wireless device 400 or wireless device 500. That is, co-located interference cancellation manager 600 may be an example of aspects of co-located interference cancellation manager 410 or co-located interference cancellation manager 510 described with reference to FIGS. 4 and 5. Separate co-located interference cancellation managers, such as illustrated in FIGS. 4 and 5, may be implemented or a common interference cancellation manager, such as illustrated in FIG. 6, may be implemented. The co-located interference cancellation manager 600 may also be an example of aspects of the co-located interference cancellation manager 705 described with reference to FIG. 7.

The co-located interference cancellation manager 600 may include auxiliary receiver tuning component 605, transmission signal converting component 610, transmission correction component 615, ADC 620, interference cancellation component 625, universal asynchronous receiver/transmitter (UART) component 630, LNA 635, demodulation component 640, interference estimation component 645, and/or auxiliary receiver 650. Each of these modules may communicate, directly or indirectly, with one another (e.g., via one or more buses).

The auxiliary receiver tuning component 605 may tune an auxiliary receiver of the first radio to the transmission frequency of the second radio, where an interference signal is converted to a baseband frequency of the second radio based on tuning the auxiliary receiver to the transmission frequency of the second radio. Additionally or alternatively, the auxiliary receiver tuning component 605 may tune the auxiliary receiver to a transmission frequency of the first radio. In some cases, the first radio may include a WWAN radio and the second radio may include a WLAN radio or Bluetooth radio.

The transmission signal converting component 610 may convert a signal from one domain to another domain. The transmission correction component 615 may perform a transmission correction procedure based on the converted transmission signal. The ADC 620 may digitize a converted interference signal, where an interference estimate is based on the digitized interference signal. The interference cancellation component 625 may perform an interference cancellation on the wireless signal based on an interference estimate. In some cases, the interference cancellation procedure is further based on a transmission signal from the first radio.

The UART component 630 may send a UART message from the second radio to the first radio, where generating an interference estimate is based on the UART message. The LNA 635 may amplify a received wireless signal to produce an amplified data signal and an amplified interference signal, where converting an interference signal to the baseband frequency of the second radio may be based on the LNA procedure. The demodulation component 640 may demodulate the data signal based on the interference cancellation.

The interference estimation component 645 may generate an interference estimate based on (e.g., based at least in part on) a converted interference signal. The auxiliary receiver 650 may be in a path used to convert a transmission signal from the first radio to a baseband frequency of the first radio when tuned to the transmission frequency of the first radio, and/or may be in a path used to convert the interference signal to a baseband frequency of the second radio when tuned to the transmission frequency of the second radio. As an example, auxiliary receiver 650 may be coupled to an output of LNA 635.

FIG. 7 shows a diagram of a system 700 including a device that supports interference cancellation in co-located multiple radio transceivers in accordance with various aspects of the present disclosure. For example, system 700 may include UE 115-b, which may be an example of a wireless device 400, a wireless device 500, or a UE 115 as described with reference to FIGS. 1, 2 and 4 through 6. UE 115-b may communicate with multiple co-located radios. For example, UE 115-b may communicate with a WWAN base station 105-b using a first radio and with a WLAN AP 205-a using a second radio.

UE 115-b may also include co-located interference cancellation manager 705, memory 710, processor 720, first radio transceiver 725, antenna 730 (e.g., for a first radio), second radio transceiver 735, and antenna 740 (e.g., for a second radio). Each of these modules may communicate, directly or indirectly, with one another (e.g., via one or more buses). The co-located interference cancellation manager 705 may be an example of a co-located interference cancellation manager as described with reference to FIGS. 4 through 6.

The memory 710 may include random access memory (RAM) and read only memory (ROM). The memory 710 may store computer-readable, computer-executable software including instructions that, when executed, cause the processor to perform various functions described herein (e.g., interference cancellation in co-located multiple radio transceivers, etc.).

In some cases, the software 715 may not be directly executable by the processor 720 but may cause a computer (e.g., when compiled and executed) to perform functions described herein. The processor 720 may include an intelligent hardware device, (e.g., a central processing unit (CPU), a microcontroller, an application specific integrated circuit (ASIC), etc.)

The multiple co-located transceivers 725 and 735 may communicate bi-directionally, via one or more antennas, wired, or wireless links, with one or more networks, as described above. For example, the transceivers 725 and 735 may communicate bi-directionally with a base station 105, a WLAN AP 205-a, or another UE 115. For example, the transceivers 725 and 735 may also include a modem to modulate the packets and provide the modulated packets to the antennas for transmission, and to demodulate packets received from the antennas.

In some cases, each transceiver (e.g., transceiver 725 and transceiver 735) may communicate using a single antenna (e.g., antenna 730 or antenna 740). However, in some cases the device may have more than one antennas, which may be capable of concurrently transmitting or receiving multiple wireless transmissions.

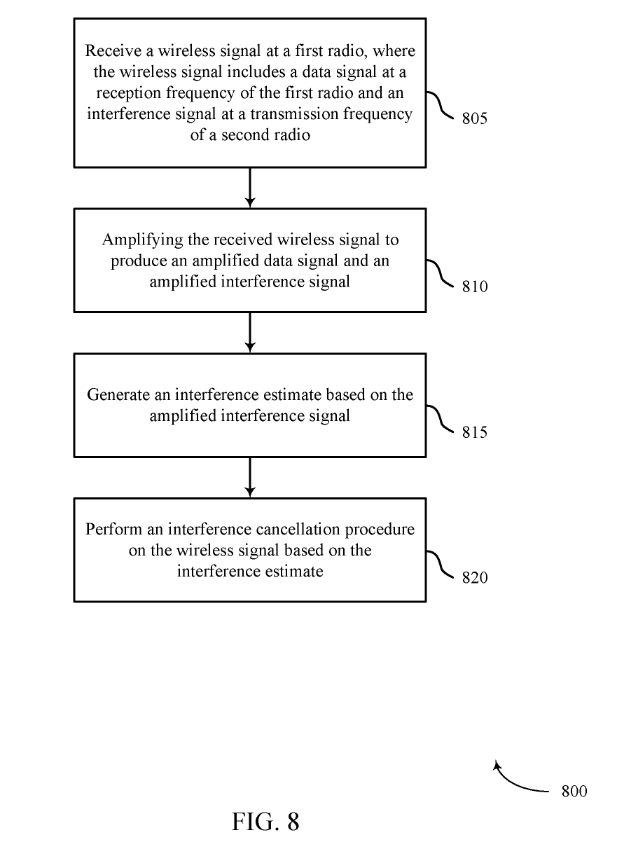

FIG. 8 shows a flowchart illustrating a method 800 for interference cancellation in co-located multiple radio transceivers in accordance with various aspects of the present disclosure. The operations of method 800 may be implemented by a device such as a UE 115 or its components as described with reference to FIGS. 1 and 2. For example, the operations of method 800 may be performed by a co-located interference cancellation manager as described herein. In some examples, the UE 115 may execute a set of codes to control the functional elements of the device to perform the functions described below. Additionally or alternatively, the UE 115 may perform aspects of the functions described below using special-purpose hardware.

At block 805, the UE 115 may receive a wireless signal at a first radio, where the wireless signal includes a data signal based on a reception frequency of the first radio and an interference signal based on a transmission frequency of a second radio as described above with reference to FIGS. 2 and 3. In certain examples, the operations of block 805 may be performed by the first radio receiver as described with reference to FIGS. 5 and 6. In some cases, the first radio communicates using a first RAT and the second radio communicates using a second RAT.

At block 810, the UE 115 may amplify the received wireless signal, for example using the LNA 315, to produce an amplified data signal and an amplified interference signal as described above with reference to FIGS. 2 and 3. In certain examples, the operations of block 810 may be performed by the LNA as described above with reference to FIGS. 5 and 6. The LNA may be selectively coupled and/or switchably coupled to the auxiliary receiver as described with reference to FIGS. 5 and 6. As an example, the auxiliary receiver may be one or more dedicated components of the receive path of the first radio (e.g., in the RF receiver or RF front end). In some cases, the auxiliary receiver may be selectively coupled and/or switchably coupled to at least one of a digital predistortion and gain control path associated with a transmit path of the first radio or a receive path associated with the first radio.

At block 815, the UE 115 may generate an interference estimate based on the amplified interference signal as described above with reference to FIGS. 2 and 3. In certain examples, the operations of block 815 may be performed by the interference estimation component as described with reference to FIGS. 5 and 6.

At block 820, the UE 115 may perform an interference cancellation procedure on the wireless signal based on the interference estimate as described above with reference to FIGS. 2 and 3. In certain examples, the operations of block 820 may be performed by the interference cancellation component as described with reference to FIGS. 5 and 6.

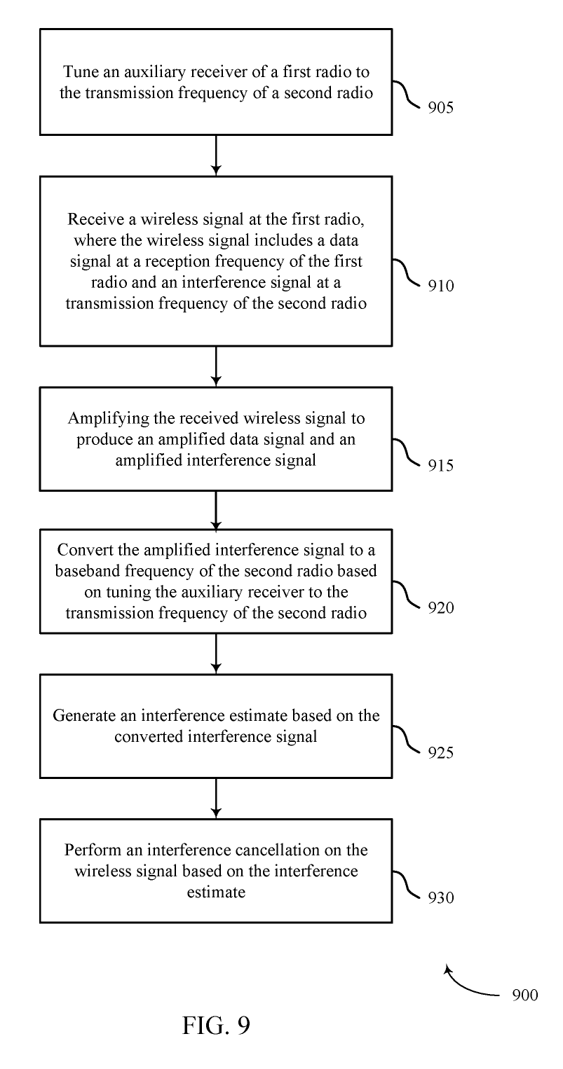

FIG. 9 shows a flowchart illustrating a method 900 for interference cancellation in co-located multiple radio transceivers in accordance with various aspects of the present disclosure. The operations of method 900 may be implemented by a device such as a UE 115 or its components as described with reference to FIGS. 1 and 2. For example, the operations of method 900 may be performed by a co-located interference cancellation manager as described herein. In some examples, the UE 115 may execute a set of codes to control the functional elements of the device to perform the functions described below. Additionally or alternatively, the UE 115 may perform aspects of the functions described below using special-purpose hardware.

At block 905, the UE 115 may tune an auxiliary receiver of a first radio to the transmission frequency of a second radio, where an interference signal is converted to a baseband frequency of the second radio based on tuning the auxiliary receiver to the transmission frequency of the second radio as described above with reference to FIGS. 2 and 3. In certain examples, the operations of block 905 may be performed by the auxiliary receiver tuning component as described with reference to FIGS. 5 and 6.

At block 910, the UE 115 may receive a wireless signal at the first radio, where the wireless signal includes a data signal based on a reception frequency of the first radio and an interference signal based on a transmission frequency of the second radio as described above with reference to FIGS. 2 and 3. In certain examples, the operations of block 910 may be performed by the first radio receiver as described with reference to FIGS. 5 and 6.

At block 915, the UE 115 may amplify the received wireless signal, for example using the LNA 315, to produce an amplified data signal and an amplified interference signal as described with reference to FIGS. 2 and 3. In certain examples, the operations of block 915 may be performed by the LNA as described with reference to FIGS. 5 and 6.

At block 920, the UE 115 may convert the amplified interference signal to a baseband frequency of the second radio as described above with reference to FIGS. 2 and 3. In certain examples, the operations of block 920 may be performed by the auxiliary receiver as described with reference to FIGS. 5 and 6.

At block 925, the UE 115 may generate an interference estimate based on the converted interference signal as described above with reference to FIGS. 2 and 3. In certain examples, the operations of block 925 may be performed by the interference estimation component as described with reference to FIGS. 5 and 6.

At block 930, the UE 115 may perform an interference cancellation on the wireless signal based on the interference estimate as described above with reference to FIGS. 2 and 3. In certain examples, the operations of block 930 may be performed by the interference cancellation component as described with reference to FIGS. 5 and 6.

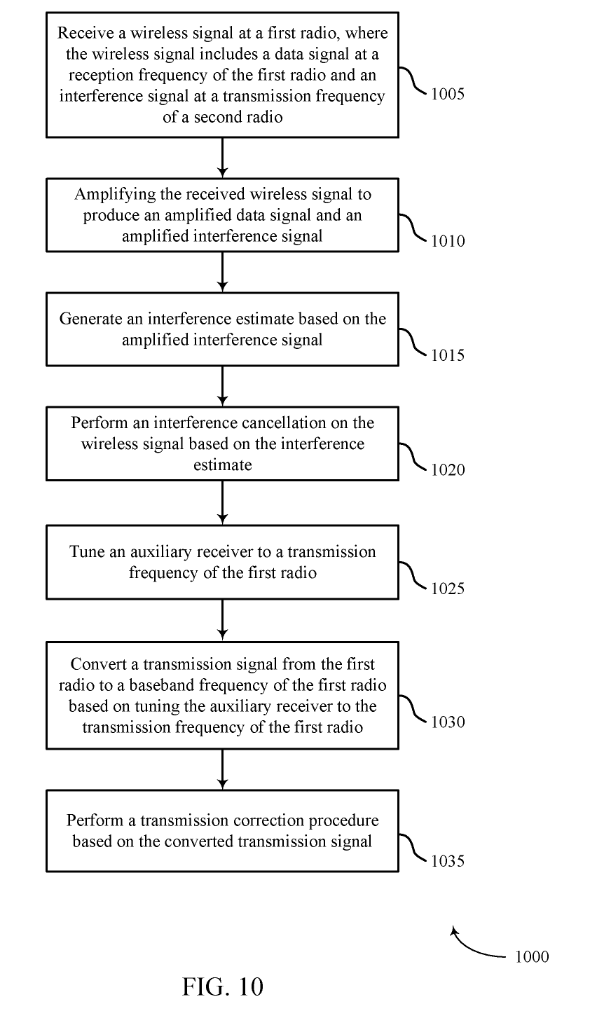

FIG. 10 shows a flowchart illustrating a method 1000 for interference cancellation in co-located multiple radio transceivers in accordance with various aspects of the present disclosure. The operations of method 1000 may be implemented by a device such as a UE 115 or its components as described with reference to FIGS. 1 and 2. For example, the operations of method 1000 may be performed by the co-located interference cancellation manager as described herein. In some examples, the UE 115 may execute a set of codes to control the functional elements of the device to perform the functions described below. Additionally or alternatively, the UE 115 may perform aspects of the functions described below using special-purpose hardware.

At block 1005, the UE 115 may receive a wireless signal at a first radio, where the wireless signal includes a data signal based on a reception frequency of the first radio and an interference signal based on a transmission frequency of a second radio as described above with reference to FIGS. 2 and 3. In certain examples, the operations of block 1005 may be performed by the first radio receiver as described with reference to FIGS. 5 and 6.

At block 1010, the UE 115 may amplify the received wireless signal, for example using the LNA 315, to produce an amplified data signal and an amplified interference signal as described above with reference to FIGS. 2 and 3. In certain examples, the operations of block 1010 may be performed by the LNA as described with reference to FIGS. 5 and 6.

At block 1015, the UE 115 may generate an interference estimate based on the amplified interference signal as described above with reference to FIGS. 2 and 3. In certain examples, the operations of block 1015 may be performed by the interference estimation component as described with reference to FIGS. 5 and 6.

At block 1020, the UE 115 may perform an interference cancellation on the wireless signal based on the interference estimate as described above with reference to FIGS. 2 and 3. In certain examples, the operations of block 1020 may be performed by the interference cancellation component as described with reference to FIGS. 5 and 6.

At block 1025, the UE 115 may tune the auxiliary receiver to a transmission frequency of the first radio as described above with reference to FIGS. 2 and 3. In certain examples, the operations of block 1025 may be performed by the auxiliary receiver tuning component as described with reference to FIGS. 5 and 6.

At block 1030, the UE 115 may convert a transmission signal from the first radio to a baseband frequency of the first radio based on tuning the auxiliary receiver to the transmission frequency of the first radio as described above with reference to FIGS. 2 and 3. In certain examples, the operations of block 1030 may be performed by the auxiliary receiver as described with reference to FIGS. 5 and 6.

At block 1035, the UE 115 may perform a transmission correction procedure based on the converted transmission signal as described above with reference to FIGS. 2 and 3. In certain examples, the operations of block 1035 may be performed by the transmission correction component as described with reference to FIGS. 5 and 6.

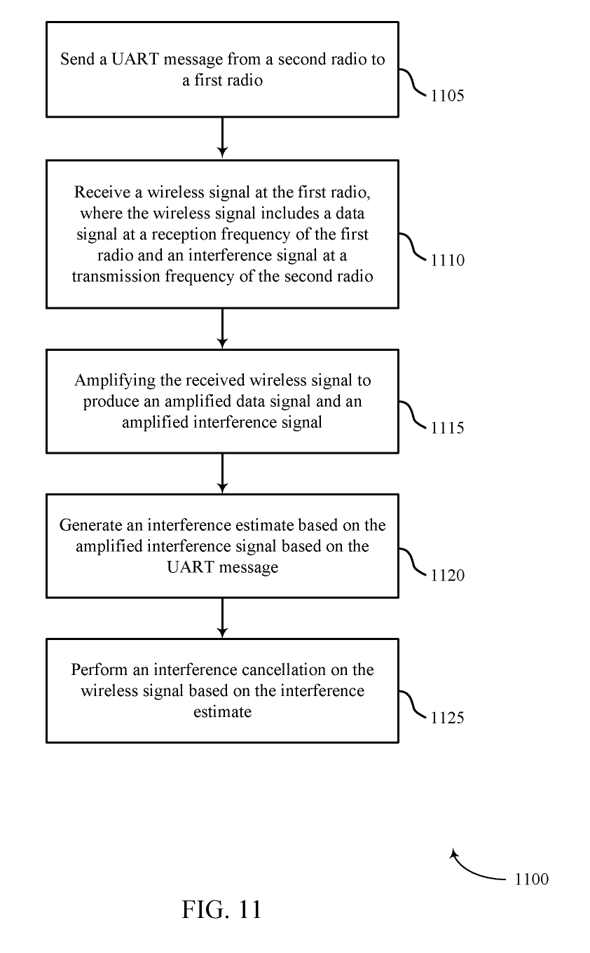

FIG. 11 shows a flowchart illustrating a method 1100 for interference cancellation in co-located multiple radio transceivers in accordance with various aspects of the present disclosure. The operations of method 1100 may be implemented by a device such as a UE 115 or its components as described with reference to FIGS. 1 and 2. For example, the operations of method 1100 may be performed by the co-located interference cancellation manager as described herein. In some examples, the UE 115 may execute a set of codes to control the functional elements of the device to perform the functions described below. Additionally or alternatively, the UE 115 may perform aspects of the functions described below using special-purpose hardware.

At block 1105, the UE 115 may send a UART message from a second radio to a first radio, where generating an interference estimate is based on the UART message as described above with reference to FIGS. 2 and 3. In certain examples, the operations of block 1105 may be performed by the UART component as described with reference to FIGS. 5 and 6.

At block 1110, the UE 115 may receive a wireless signal at the first radio, where the wireless signal includes a data signal based on a reception frequency of the first radio and an interference signal based on a transmission frequency of the second radio as described above with reference to FIGS. 2 and 3. In certain examples, the operations of block 1110 may be performed by the first radio receiver as described with reference to FIGS. 5 and 6.

At block 1115, the UE 115 may amplify the received wireless signal, for example using the LNA 315, to produce an amplified data signal and an amplified interference signal as described above with reference to FIGS. 2 and 3. In certain examples, the operations of block 1115 may be performed by the LNA as described with reference to FIGS. 5 and 6.

At block 1120, the UE 115 may generate an interference estimate based on the amplified interference signal as described above with reference to FIGS. 2 and 3. In certain examples, the operations of block 1120 may be performed by the interference estimation component as described with reference to FIGS. 5 and 6.

At block 1125, the UE 115 may perform an interference cancellation on the wireless signal based on the interference estimate as described above with reference to FIGS. 2 and 3. In certain examples, the operations of block 1125 may be performed by the interference cancellation component as described with reference to FIGS. 5 and 6.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for interference cancellation in co-located multiple radio transceivers.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an AP, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

Thus, aspects of the disclosure may provide for interference cancellation in radio transceivers. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A device for wireless communication, comprising:
a first radio configured to process signals received wirelessly at a reception frequency, the first radio comprising a receive chain, an auxiliary receive chain, and an interference cancellation circuit; and
a second radio configured to generate signals for wireless transmission at a transmission frequency,
wherein the first radio is configured to process a first signal that includes a data signal received in the reception frequency and an interference signal based on the transmission frequency,
the receive chain comprises a low noise amplifier (LNA) configured to output an amplified signal having an amplified interference signal and an amplified data signal,
an input of the auxiliary receive chain is configured to be coupled to the receive chain such that the amplified interference signal output by the LNA is input to the auxiliary receive chain, and
the interference cancellation circuit is configured to generate an interference estimate based at least in part on the amplified interference signal and apply the interference estimate to the amplified signal of the receive chain.

2. The device of claim 1, further comprising:
a switch configured to selectively couple the input of the auxiliary receive chain to one of an output of the LNA, an antenna coupled to the first radio, or an output of a power amplifier of a transmit chain of the first radio.

3. The device of claim 1, wherein the auxiliary receive chain further comprises:
a downconverter configured to convert the amplified interference signal to a baseband frequency of the second radio.

4. The device of claim 1, wherein the auxiliary receive chain further comprises:
a tuning frequency input for selectively tuning the auxiliary receive chain to the transmission frequency of the second radio or a transmission frequency of the first radio.

5. The device of claim 1, wherein the auxiliary receive chain further comprises:
an analog-to-digital converter configured to convert the amplified interference signal to a digitized amplified interference signal, wherein the interference cancellation circuit is configured to generate the interference estimate based at least in part on the digitized amplified interference signal.

6. The device of claim 5, wherein the first radio further comprises a transmit chain comprising a power amplifier having an output selectively coupled to the input of the auxiliary receive chain, wherein an output of the analog-to-digital converter is coupled to an input of the transmit chain.

7. The device of claim 1, wherein the first radio is configured to use a first radio access technology (RAT) and the second radio is configured to use a second RAT.

8. The device of claim 7, wherein the reception frequency of signals received by the first radio configured to use the first RAT is different from the transmission frequency of signals generated for wireless transmission at the second radio configured to use the second RAT.

9. A method of wireless communication at a device comprising a first radio co-located with a second radio, the method comprising:
receiving a wireless signal at the first radio, wherein the wireless signal comprises a data signal based on a reception frequency of the first radio and an interference signal based on a transmission frequency of the second radio;
amplifying the received wireless signal to produce an amplified data signal and an amplified interference signal;
generating an interference estimate based at least in part on the amplified interference signal; and
performing an interference cancellation procedure on the received wireless signal based at least in part on the interference estimate.

10. The method of claim 9, further comprising:
processing the amplified data signal in a first receive path using at least a first downconverter and processing the amplified interference signal in a second receive path using at least a second downconverter, wherein the interference estimate is based at least in part on the amplified interference signal processed in the second receive path, and wherein the performing is based at least in part on the amplified data signal processed in the first receive path.

11. The method of claim 9, further comprising:
tuning an auxiliary receiver of the first radio to the transmission frequency of the second radio; and
converting the amplified interference signal to a baseband frequency of the second radio based at least in part on tuning the auxiliary receiver to the transmission frequency of the second radio.

12. The method of claim 11, further comprising:
tuning the auxiliary receiver to a transmission frequency of the first radio;
converting a transmission signal from the first radio to a baseband frequency of the first radio based at least in part on tuning the auxiliary receiver to the transmission frequency of the first radio; and
performing a transmission correction procedure based at least in part on the converted transmission signal.

13. The method of claim 11, wherein the auxiliary receiver is selectively coupled to at least one of a digital predistortion and gain control path associated with a transmit path of the first radio, or a receive path associated with the first radio.

14. The method of claim 11, further comprising:
determining to convert the amplified interference signal to the baseband frequency of the second radio; and
selectively causing the auxiliary receiver to switch coupling from a digital predistortion and gain control path associated with the transmit path of the first radio to the receive path associated with the first radio.

15. The method of claim 9, further comprising:
digitizing the amplified interference signal, wherein the interference estimate is based at least in part on the digitized interference signal.

16. The method of claim 9, further comprising:
converting the data signal to a baseband data signal, wherein performing the interference cancellation procedure is based at least in part on the baseband data signal.

17. The method of claim 9, further comprising:
converting the amplified interference signal to a baseband frequency of the second radio.

18. The method of claim 9, wherein the first radio comprises a wireless wide area network (WWAN) radio and the second radio comprises a wireless local area network (WLAN) radio.

19. The method of claim 9, wherein the interference cancellation procedure is further based on a transmission signal from the first radio.

20. The method of claim 9, further comprising:
sending a universal asynchronous receiver/transmitter (UART) message from the second radio to the first radio, wherein generating the interference estimate is based at least in part on the UART message.

21. The method of claim 9, further comprising:
demodulating the data signal based at least in part on the interference cancellation procedure.

22. An apparatus for wireless communication at a device, the apparatus comprising:
means for transmitting a first wireless signal at a transmission frequency;
means for receiving a second wireless signal, wherein the second wireless signal comprises a data signal based on a reception frequency of the means for receiving and an interference signal based on the transmission frequency;
means for performing a low noise amplification of the received wireless signal and outputting an amplified data signal and an amplified interference signal;
means for generating an interference estimate based at least in part on the amplified interference signal; and
means for performing an interference cancellation procedure on the received wireless signal based at least in part on the interference estimate.

23. The apparatus of claim 22, further comprising:
means for tuning an auxiliary receiver of the means for receiving to the transmission frequency; and
means for converting the amplified interference signal to a baseband frequency of the means for transmitting

24. An apparatus, comprising:
a low noise amplifier (LNA) having an input coupled to a first antenna and an LNA output, wherein the LNA is configured to provide at the output an amplified signal based on a first signal wirelessly received at the first antenna;
a data processing path coupled to the LNA output and comprising a first receiver; and
an interference processing path coupled to the LNA output and comprising a feedback receiver.

25. The apparatus of claim 24, further comprising:
a combiner configured to combine an output of the data processing path with an output of the interference processing path.

26. The apparatus of claim 24, further comprising:
a power amplifier coupled to the interference processing path.

27. The apparatus of claim 26, further comprising:
a multiplexer configured to selectively couple the LNA output or the power amplifier to circuitry in the feedback receiver.

28. The apparatus of claim 24, wherein the apparatus is implemented in a first device and is configured to transmit and receive wireless signals using a first radio access technology (RAT), wherein the first device further comprises a transceiver coupled to a second antenna configured to transmit and receive wireless signals using a second RAT.
